(19) United States
(12) Patent Application Publication
(10) Pub. No.: US 2017/0046726 A1
(43) Pub. Date: Feb. 16, 2017

(54) INFORMATION PROCESSING DEVICE, INFORMATION PROCESSING METHOD, AND PROGRAM

(71) Applicant: International Business Machines Corporation, Armonk, NY (US)

(72) Inventors: Hideyuki Mizuta, Tokyo (JP); Rikiya Takahashi, Yokohama (JP)

(21) Appl. No.: 15/340,748

(22) Filed: Nov. 1, 2016

Related U.S. Application Data
(63) Continuation of application No. 14/551,146, filed on Nov. 24, 2014.

(30) Foreign Application Priority Data
Nov. 28, 2013 (JP) 2013-246269

(51) Int. Cl. G06Q 30/02

(52) U.S. Cl. CPC G06Q 30/0202; G06Q 30/0241

(57) ABSTRACT

An information processing device which selects a set of items to be recommended for a user out of a set of items. The information processing device includes: (a) a selection unit which: (i) calculates priority which is high in the case of a high score of an item itself and low in the case of a high degree of similarity to another selected item with respect to each of the plurality of items, and (ii) selects a set of items out of the plurality of items on the basis of the priority; and (ii) an output unit which outputs each item included in the selected set of items as an item to be presented to the user.

### BACKGROUND OF THE INVENTION

The present invention relates to an information processing device, an information processing method, and a program for information processing.

It is known that “word-of-mouth” (that is, comments made by people during relatively informal and generally unstructured conversations, transmissions or other person to person communication types) influences on human consumers' purchase decisions. Moreover, there is known a method of modeling dependencies between multiple events which human consumers experience.

### SUMMARY

According to an aspect of the present invention, there is a method, computer program product and/or system for information processing that performs the following steps (not necessarily in the following order): (i) receiving first historical data set including: (a) identifying information identifying a set of individuals, (b) respectively corresponding to each individual, a set of event series with each event series including a set of events believed to be potentially relevant to a corresponding individual's behavior, and (c) respectively corresponding to each event series, a set of actual response value(s), with each response value numerically indicating a corresponding individual's actual behavior believed to have been potentially influenced by the corresponding event series; (ii) calculating, for each event series and using a first regression model, a set of predicted response value(s), with each predicted response value numerically indicating a prediction the corresponding individual's believed to have been potentially influenced by the corresponding event series, with each predicted response value corresponding to an actual response value; and (iii) calculating, for each corresponding actual response value and predicted response value for each event series of each individual, an interaction factor which is based upon the difference between the corresponding actual response and the predicted response value.

### BRIEF DESCRIPTION OF THE DRAWINGS

FIG. 1 is a diagram illustrating the configuration of information processing device 10 according to an embodiment.

FIG. 2 is a processing flow of the information processing device 10 according to the embodiment.

FIG. 3 is detailed processing flow corresponding to step S110 of FIG. 2 processing flow.

FIG. 4 is detailed processing flow corresponding to step S120 of FIG. 2 processing flow.

FIG. 5 is detailed processing flow corresponding to step S140 of FIG. 2 processing flow.

FIG. 6 (A and B) is a diagram illustrating an example of event series and response series according to the embodiment.

FIG. 7 is a diagram illustrating prediction data predicted according to a first regression model of the embodiment.

FIG. 8 is a diagram illustrating an example of interaction factors according to the embodiment.

FIG. 9 is a diagram illustrating an example of a pattern of an interaction factors in the embodiment.

FIG. 10 is a diagram illustrating an example of grouping in the embodiment.

FIG. 11 is a diagram illustrating an example of group response series in the embodiment.

FIG. 12 is a diagram illustrating individual weight vectors and group weight vectors in the embodiment.

FIG. 13 is a processing flow of the information processing device 10 according to a variation of the FIG. 2 processing flow.

FIG. 14 is detailed processing flow corresponding to step S240 of FIG. 13 processing flow.

FIG. 15 is a diagram illustrating an example of group generation in the variation of FIG. 14.

FIG. 16 is a diagram illustrating an example of the hardware configuration of a computer suitable for implementing some embodiments of the present invention.

### DETAILED DESCRIPTION

Some embodiments of the present invention recognize that: (i) in modeling word-of-mouth as in a conventional model (that is, a structured set of data) which shows dependency among many consumers, it is helpful to introduce and fit huge number of parameters proportional to the square of the number of consumers; and (ii) in these currently conventional models, realistic predictive models with feasible computational costs cannot be acquired.

According to a first aspect of the present invention, an information processing device selects a set of items to be recommended for a user out of a set of multiple of candidate items. In this embodiment, the information processing device includes: (i) a selection unit which: (a) calculates priority which is high in the case of a high score of an item itself and low in the case of a high degree of similarity to another selected item with respect to each of the candidate items, and (b) selects a set of items out of the candidate items on the basis of the priority; and (ii) an output unit which outputs each item included in the selected set of items as an item to be presented to the user. As can be seen from the foregoing description, an embodiment of an information processing method is performed by the information processing device. The information processing device uses machine logic (for example, a software program) to perform the operations of the information processing method.

Hereinafter, the present invention will be described in terms of one, or more, embodiment(s). It should be noted, however, that the following embodiments are not intended to limit the scope of the appended claims, and that not all the combinations of features described in the embodiments are necessarily essential to the present invention.

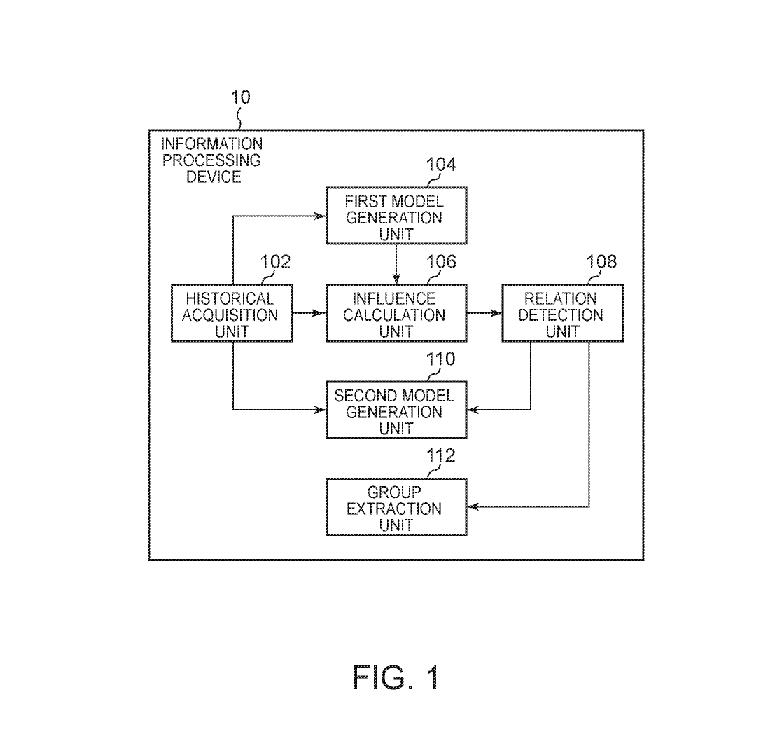

FIG. 1 illustrates the configuration of an information processing device 10 according to an embodiment. The information processing device 10 generates multiple regression models (which may sometimes herein be referred to as “candidate” models) to predict the response by an individual, who is influenced by word-of-mouth, or the like, from other individuals, using event series data containing the responses by the individuals and the actions targeted to these individuals. The information processing device 10 includes a history acquisition unit 102, a first model generation unit 104, an influence calculation unit 106, a relation detection unit 108, a second model generation unit 110, and a group extraction unit 112.

The history acquisition unit 102 acquires historical data of the event series containing actions targeted to individuals and the responses by each of these individuals. The history acquisition unit 102 supplies the acquired historical data of the event series to the first model generation unit 104, the influence calculation unit 106, and the second model generation unit 110.

The first model generation unit 104 generates a first regression model for predicting the response by an individual given the historical events associated with the individual itself, by learning parameters using a historical dataset of event series or by some other methods. The first model generation unit 104 supplies the first regression model to the influence calculation unit 106.

The influence calculation unit 106 generates scores of the predicted response series that the first regression model provides, and calculates a time series of regression residuals that represent the differences between the actually observed responses by each of the individuals and the predicted scores generated from the first regression model or the like. The time series of regression residuals represent interaction factors which cannot be explained by using only the first regression model. The information processing device 10 of this embodiment assumes that the regression residuals are generated by the influence of word-of-mouth or the like from other individuals. The influence calculation unit 106 supplies the interaction factors to the relation detection unit 108.

The relation detection unit 108 detects an inter-personal relationship between a set of individuals on the basis of the residual time series calculated for each of the plurality of individuals. For example, on the assumption that individuals that have similar values of the residual time series will belong to a single group influenced by common trends of word-of-mouth, the relation detection unit 108 collects individuals similar to each other in terms of the interaction factors to classify the plurality of individuals into two or more groups.

The relation detection unit 108 supplies the interaction factors and a result of grouping the plurality of individuals to the group extraction unit 112. Moreover, the relation detection unit 108 supplies the result of grouping the plurality of individuals to the second model generation unit 110.

The second model generation unit 110 generates a plurality of second regression models where each second regression model predicts the response by an individual who belongs to one of the identified groups, using the event series for the individual itself and other individuals belonging to the same group.

The group extraction unit 112 extracts a group that is highly influenced by other individuals among a plurality of groups classified by the relation detection unit 108, in comparison with other groups.

In this manner, the information processing device 10 of this embodiment derives the regression residuals which represents a statistical error between the prediction result by the first regression model generated from the event series and an actual result, groups individuals on the basis of the interaction factors, and generates the second regression models reflecting the set of event series for each group. Then, the information processing device 10 predicts the response by an individual on the basis of one of the second regression models and thus is able to generate a model incorporating word of mouth or the like from other individuals without setting many parameters whose number is proportional to the square of the number of individuals.

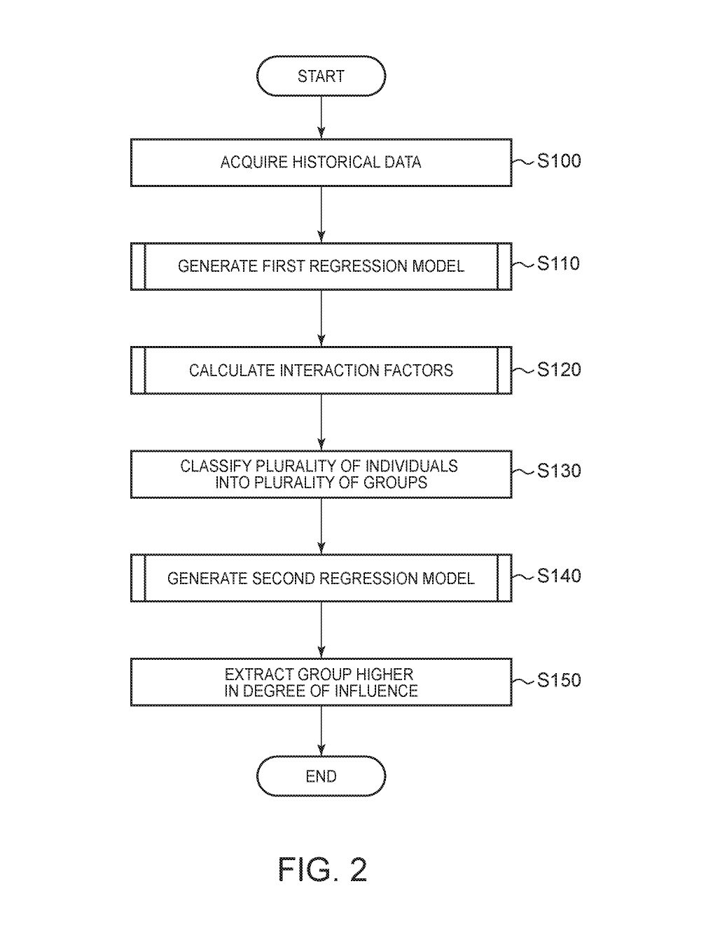

FIG. 2 illustrates a processing flow of the information processing device 10 of this embodiment. In this embodiment, the information processing device 10 performs processes of steps S100 to S150 to generate the second regression model and extracts a group which receives significant influence of word-of-mouth.

First, in step S100, the history acquisition unit 102 acquires historical data of event series given to an individual containing the responses by the individual and actions targeted to the individual. For example, the history acquisition unit 102 may acquire time series data such as advertisements of commodities given to a consumer in the past, e-mail distributions, and/or a web browsing history of the consumer, as historical data of the event series, from a database or the like.

Moreover, the history acquisition unit 102 may acquire time series data of the number of responses by the individual and/or the response amounts. For example, the history acquisition unit 102 may acquire time series data of information indicating purchase amounts for a consumer (e.g., number of purchase transactions, purchase quantity and/or purchase amount, purchase date and time, or the like) as the historical data of the event series from a database or the like.

Here, the history acquisition unit 102 may include at least parts of the historical data of the event series. The history acquisition unit 102 supplies the acquired historical data of the event series to the first model generation unit 104, the influence calculation unit 106, and the second model generation unit 110.

Next, in step S110, the first model generation unit 104 generates a first regression model for predicting the response by an individual depending on the past events associated with the individual itself on the basis of the historical data of the event series. In the case where at least part of the event series includes a sequence of responses, the first model generation unit 104 may generate an autoregressive model as the first regression model. The first model generation unit 104 generates the first regression model by using events associated with only the individual itself (and/or a response event to be output from the same individual) as explanatory variables. The first model generation unit 104 supplies the generated first regression model to the influence calculation unit 106. The concrete content of the process of step S110 will be described later.

Next, in step S120, the influence calculation unit 106 calculates a series of interaction factors. For example, first, the influence calculation unit 106 generates predicted scores of the response by applying the first regression model for a historical dataset of the event series, with respect to a plurality of individuals. Subsequently, the influence calculation unit 106 calculates a series of interaction factors which includes the amount with which each individual is influenced by other individuals, with respect to the plurality of individuals, on the basis of a difference between data obtained by smoothing the observed response series in the historical data by a plurality of periods having predetermined time intervals and the predicted scores of the responses by the first regression model or the like.

As an example, the influence calculation unit 106 may calculate the time series of a difference in the number of responses (e.g., the number of purchase transactions) or a response amount (e.g., sales revenue) per predetermined interval (e.g., one day, one week, or one month) in the time series of the historical data and the time series of the predicted scores based on the first regression model as the series of interaction factors. The concrete content of the process of step S120 will be described later.

Next, in step S130, the relation detection unit 108 classifies the plurality of individuals into two or more groups on the basis of the similarity between respective two of the plurality of the series of interaction factors. For example, the relation detection unit 108 clusters the plurality of individuals into a plurality of groups so that individuals having vectors, which are formed from the interaction factors and close to each other in distance, belong to the same group by using an m-means method or the like.

The series of interaction factors represents the amount with which an individual is influenced by other individuals, and which cannot be explained by the first regression model. This is considered to be because the response series by the individual is caused not only by the event series corresponding to the advertisement distribution or the like and the response series itself corresponding to the past purchase by the same individual, but also by social influence from other individuals like word of mouth or the like.

Here, it is thought that a plurality of individuals having similar values of the interaction factors, in other words, having interaction-factor vectors close to each other in distance follow similar social trends such as word of mouth generated therein. For example, in the case of a plurality of individuals having interaction factors whose values increase in the first half of the target period and decrease in the second half of the target period, all of the individuals are thought to be greatly influenced by word of mouth and stimulated their purchases in relatively early time while not so much influenced by word of mouth in the second half of the target period. It is conveniently assumable that the plurality of individuals as described above belongs to, for example, a single group relatively sensitive to such social trend.

Moreover, for example, in the case of a plurality of individuals having the interaction factors whose value decrease in the first half of the target period while increase in the second half of the target period, all of the individuals are thought to perform purchase decisions without influence of word of mouth in early time, but greatly influenced by word of mouth in the second half of the target period. It is conveniently assumable that the plurality of individuals as described above belongs to, for example, a single group relatively insensitive to the social trend.

Therefore, the relation detection unit 108 classifies the plurality of individuals according to the pattern of the influence of the word of mouth by grouping the plurality of individuals on the basis of the interaction factors. The relation detection unit 108 supplies the interaction factors and the result of grouping the plurality of individuals to the group extraction unit 112. In addition, the relation detection unit 108 supplies the result of grouping the plurality of individuals to the second model generation unit 110.

Next, in step S140, the second model generation unit 110 generates a plurality of second regression models for predicting the response by the individual depending on the event series for the individual itself and on the collective amount of the responses by the group to which the individual belongs, with respect to the individuals included in the group. Specifically, the second model generation unit 110 generates the second regression models in which the influence from other individuals in the group is added as an explanatory variable in addition to the event input to the individual itself (and/or a response event output from the individual).

For example, the second model generation unit 110 may generate one of the second regression models by using a series of the total number of responses or response amounts summed over every individual in the group as a group response series. In one example, the second model generation unit 110 may generate one of the second regression models for predicting the response by a consumer by using the total number of responses or response amounts summed over every individual in the group (e.g., the sum of the numbers of purchases in the group) as a group response series.

Moreover, the second model generation unit 110 may generate the second regression model by using the event series used by the first model generation unit 104 in step S110 as the event series of the individual itself For example, the second model generation unit 110 may use the time series data of an advertisement or the like of a commodity for a consumer him/herself included in the group as the event series for the individual itself. The concrete content of the process of step S140 will be described later.

Next, in step S150, the group extraction unit 112 extracts a group that is highly influenced by other individuals among a plurality of groups classified by the relation detection unit 108, in comparison with other groups. For example, the group extraction unit 112 may extract a group having a higher maximum value in a single period with respect to the interaction factors or a higher total value in all periods with respect to the magnitude of the interaction factors among a plurality of groups, in comparison with other groups, as a group highly influenced by other individuals. Thereby, the group extraction unit 112 extracts a group including individuals that are highly influenced by word of mouth or the like from other individuals, in comparison with other groups.

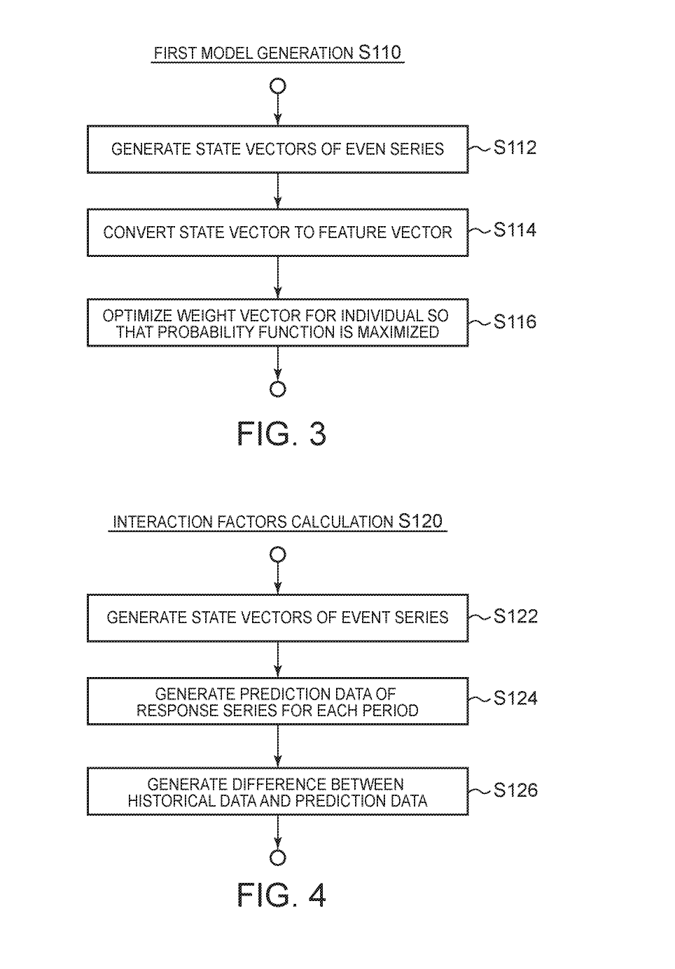

FIG. 3 illustrates a processing flow in step S110 of this embodiment. The first model generation unit 104 performs the process of step S110 by performing the processes of steps S112 to S116.

First, in step S112, the first model generation unit 104 generates state vectors of the event series. For example, the first model generation unit 104: (i) divides the period related to the event series into n unit periods T₁ to Tₙ each unit period having a predetermined interval At (for example, one day, one week, or one month); and (ii) generates a state vector corresponding to an event of the event series in each of the unit periods T₁ to T. The first model generation unit 104 may generate the state vectors of all unit periods included in the event series for all individuals.

For example, consider a case where a direct mail is sent twice and a TV (broadcast television) commercial is broadcasted once in the first week period T₁ for an individual i, and after these promotional communications are made, the individual i purchases certain commodities for 1,000 yen in total in the first week. In response, the first model generation unit 104 generates a state vector xᵢ₁=(2, 1, 1000) of the first week of the individual i. Carrying this example case further in time, during a second week period T2, a direct mail is sent twice to individual i and no broadcast television commercial is broadcasted. After week T2, individual i purchased certain commodities for 500 yen in total. In response, the first model generation unit 104 generates a state vector xᵢ₂=(2, 0, 500) cover week T2 with respect to individual i.

Next, in step S114, the first model generation unit 104 converts the generated state vector to a feature vector. For example, the first model generation unit 104 converts a state vector xᵢⱼ to a corresponding feature vector Φ(xᵢⱼ) by using an arbitrary mapping function Φ:R^{d1}→R^{d2} which has been designed a priori (that is, the arbitrary mapping function is predetermined). In this notation, d1 indicates a dimension corresponding to the state vector and d2 indicates the dimension corresponding to the feature vector.

In tis example case, the first model generation unit 104 converts the state vector xᵢⱼ into the feature vector Φ(xᵢⱼ) by adding a quadratic interaction term to the state vector xᵢⱼ. For example, the first model generation unit 104 may convert the state vector xᵢⱼ into the feature vector Φ(xᵢⱼ) by applying a gradually decreasing function (for example, f(x)=x/(x+a), where a is a constant) to each element of the state vector xᵢⱼ. Alternatively, the first model generation unit 104 may use the state vector xᵢⱼ as a feature vector Φ(xᵢⱼ) directly, without converting the state vector xᵢⱼ to the feature vector Φ(xᵢⱼ).

Next, in step S116, the first model generation unit 104 optimizes a weight vector preset for each individual so that data likelihood function is maximized. Specifically, first, the first model generation unit 104 acquires the number of responses yᵢⱼ which is the frequency with which that the individual i responded in each period Tⱼ from the historical data of the response series. Alternatively, the first model generation unit 104 may define yᵢⱼ as a “response amount,” rather than a response frequency,” where “response amount” indicates the amount of content in individual i's responses, rather than the number of responses which is indicated when yᵢⱼ is defined in terms of “response frequency.” Going forward in the example at hand, the first model generation unit 104 uses a version of yᵢⱼ that is determined based on “response frequency.”

Subsequently, the first model generation unit 104 computes a scalar score by an inner product between the feature vector Φ(xᵢⱼ) and the weight vector wᵢ for each period j with respect to the individual i. Then, the first model generation unit 104 calculates the logarithm of a probability with which the number of responses yᵢⱼ is generated from a Poisson distribution. In this calculation of a logarithm of probability, a product of the exponential function of the computed scalar score and the length At of the period Tⱼ is an expected value. After that, the first model generation unit 104 optimizes the weight vector wᵢ so that the “total logarithmic likelihood” is maximized. The “total logarithmic likelihood” is the sum of the logarithmic probabilities in all periods.

As an example, the first model generation unit 104 optimizes the weight vector wᵢ preset for each of m individuals (i=1 to m) by solving an optimization problem represented by Expression 1 (set forth below). Incidentally, bᵢ is a bias term. Specifically, the first model generation unit 104 performs Poisson regression for each of the plurality of individuals. The first model generation unit 104 may use the maximum likelihood estimation, Maximum A Posteriori (MAP) estimation, Bayesian estimation, or the like as a method of optimizing Expression 1. Here, the first model generation unit 104 may use a bias term b and/or a weight vector w not independent of the individual i as the bias term bᵢ and/or the weight vector wᵢ. Expression 1 follows:

$${max}_{{w}_{1} , {w}_{2} , … , {w}_{m}} {\sum }_{i = 1}^{m} {\sum }_{j = 1}^{n} l ( {y}_{ij} ; {b}_{i} + {w}_{i}^{T} Φ ( {x}_{ij} ) , Δ t )$$

At this point in the processing in this example, the first model generation unit 104 uses a function in which the normalization term (partition function) for the number of times of response is removed from the logarithmic probability mass function. This function is based on the probability that an event occurs given the number of times of response during the target period. This target period is the period in the Poisson process in which the expected value of the number of event occurrences per unit time is the exponential function of a scalar score as the probability function of Expression 1 (shown, below, as Expression 2). The first model generation unit 104 is able to perform optimization in consideration of the irreversibility of time by removing the regularization term. Expression 2 is as follows:

l(y; z, τ)=yz−τexp (z)

where y is the number of response transactions, z is a scalar score which is to be the logarithm related to the expected value of the number of response transactions, and τ is the length of the target period. In this manner, the first model generation unit 104 generates the first regression model by optimizing the weight vector wᵢ for a set of individuals.

FIG. 4 illustrates the processing flow in step S120 of this embodiment. The influence calculation unit 106 performs the process of step S120 by performing the processes of S122 to S126.

First, in step S122, the influence calculation unit 106 generates state vectors of event series with respect to the plurality of individuals. The influence calculation unit 106 divides the period related to the event series into n unit periods T₁ to Tₙ each having a predetermined interval Δt (for example, one day, one week, or one month) and generates a state vector corresponding to an event of the event series in each of the unit periods T₁ to Tₙ in the same manner as in the process of step S112.

Here, the event series used by the influence calculation unit 106 for generating the state vector may be the same event series in the same period as the event series used in step S112 or alternatively may be a different event series in a different period.

Next, in step S124, the influence calculation unit 106 estimates the number of responses yᵢ₁ to yᵢₙ (or, alternatively, the response amounts yᵢ₁ to yᵢₙ). As a further alternative, the response amount and response frequency may be combined into a single value, with yᵢ₁ to yᵢₙbeing defined to reflect the combination of response amount and response frequency. However specifically calculated, the variables yᵢ₁ to yᵢₙ: (i) these variables should realistically indicate the magnitudes of response of the individual i respectively corresponding to the plurality of unit periods T₁ to Tₙ; and (ii) are based, in part, upon state vectors xᵢ₁ to xᵢₙ corresponding to the plurality of unit periods T₁ to Tₙ with respect to individual i.

For example, first, the influence calculation unit 106 converts the plurality of state vectors xᵢⱼ to a plurality of feature vectors Ω(xᵢⱼ) in the same manner as in step S114. Subsequently, the influence calculation unit 106 calculates a scalar score obtained by an inner product between the feature vector Ω(xᵢⱼ) of the individual i and the weight vector wᵢ included in the first regression model with respect to each of the plurality of periods Tⱼ where j=1 to n. The influence calculation unit 106 calculates an average number of responses (or an average response amount. Alternatively, their combination is simply referred to as the average number of responses) in the plurality of periods Tⱼ where j=1 to n from a product between an exponential function which has a scalar score as an independent variable and has a Napier's constant as a base and the time interval Δt to obtain prediction data of response series.

Next, in step S126, the influence calculation unit 106 generates a difference between the response series in the historical data and the predicted scores about the response series. For example, first, the influence calculation unit 106 divides the period related to the response series in the historical data into n periods T₁ to Tₙ each having an interval Δt and calculates the number of responses of the response series in the periods T₁ to T. Subsequently, the influence calculation unit 106 calculates a difference between: (i) the average number of responses of the individual i in the periods T₁ to Tₙ calculated in step S124; and (ii) the number of responses of the response series of the individual i in the periods T₁ to Tₙ. This difference is used to calculate the interaction factors in the periods T₁ to Tₙ of the individual i.

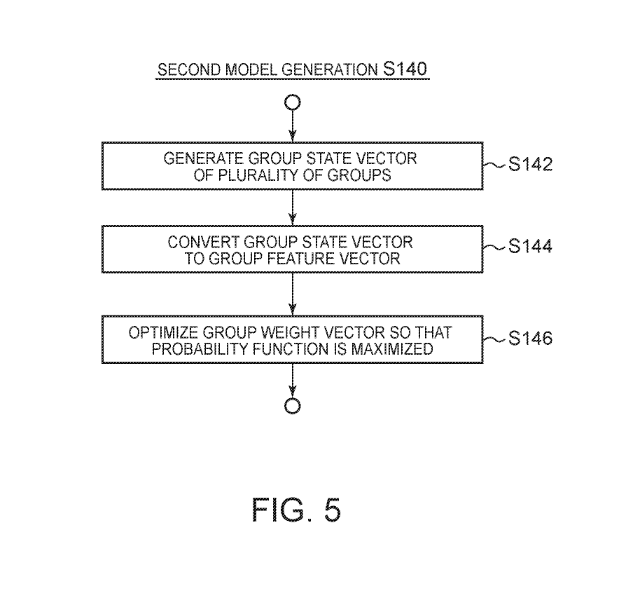

FIG. 5 illustrates the processing flow in step S140 according to this embodiment. The second model generation unit 110 performs the process of step S140 by performing the processes of steps S142 to S146.

First, in step S142, the second model generation unit 110 generates a group response series. For example, the second model generation unit 110 calculates the total value about the number of responses and/or the response amount of the individuals in a group, with respect to p groups generated in step S130. As an example, the second model generation unit 110 calculates a group state vector z_{cj} which represents the total value about the number of responses or the like of a group c in a period Tⱼ, with respect to all periods where j=1 to n.

Moreover, the second model generation unit 110 generates the state vector of an event series for each individual. The second model generation unit 110 may generate the state vector of an event series for each individual by performing the same process as the process of step S112.

Next, in step S144, the second model generation unit 110 calculates a group feature vector Ψ(z_{cj}) from a group state vector z_{cj}. The second model generation unit 110 may calculate a group feature vector Φ(z_{cj}) by using a mapping function in the same manner as in step S114. In addition, the second model generation unit 110 generates feature vectors Φ(xᵢⱼ) of the plurality of individuals from the state vectors xᵢⱼ of the respective individuals in the same manner as in step S114.

Next, in step S146, the second model generation unit 110 optimizes the group weight vector which has been set for each group so that the probability function is maximized. Specifically, first, the second model generation unit 110 acquires the actual number of responses yᵢⱼ of the individual i in each period Tⱼ from the historical data of the response series similarly to the process of step S116.

Next, in step S146, the second model generation unit 110 optimizes an individual weight vector w_{c[i]} and a group weight vector θ_{c[i]c′} which have been set for each group so that the probability function is maximized. In this regard, the individual weight vector w_{c[i]} is a vector which is common to the individuals belonging to a group c[i] to which the individual i belongs. Moreover, the group weight vector θ_{c[i]c′} may be a vector indicating the degree that the group c[i] to which the individual i belongs is influenced by the group response series of the group c′. Incidentally, the group c′ may include the same group as the group c[i].

Subsequently, for the period j, the second model generation unit 110 computes a first scalar score by an inner product between the individual weight vector w_{c[i]} of the group c[i] to which the individual i belongs and the feature vector Φ(xᵢⱼ). Moreover, for the period j, the second model generation unit 110 generates a second scalar score by an inner product between the group weight vector θ_{c[i]c′} of the group c[i] to which the individual i belongs and the group c′ and the group feature vector Ψ(z_{c′j}) generated from the group response series of the group c′ for p groups c′ and sums the first scalar score and the second scalar score.

Subsequently, the second model generation unit 110 calculates the logarithm of probability with which the number of responses yᵢⱼ is generated from a Poisson distribution where a product of the exponential function of the computed sum of the first and second scalar scores and the time interval Δt of the period Tⱼ is an expected value. In the last place, the second model generation unit 110 optimizes the individual weight vector w_{c[i]} and the group weight vector θc_{[i]c′} so that the total of the logarithmic probabilities in all periods is maximized.

As an example, the second model generation unit 110 optimizes a bias term b_{c[i]}, an individual weight vector w_{c[i]}, which are set for each of p groups where c=1 to p, and a group weight vector θ_{cc′}, which is set for p×p combinations, by solving an optimization problem represented by Expression 3 (set forth, below). Specifically, the second model generation unit 110 performs Poisson regression for each of the plurality of individuals. The second model generation unit 110 may use the maximum likelihood estimation, MAP estimation, Bayesian estimation, or the like as a method of optimizing the Expression 3. Moreover, the second model generation unit 110 may use a bias term b, a weight vector wᵢ, and/or a weight vector θ_{ic′} for each individual i, instead of the bias term b_{c[i]}, the individual weight vector w_{c[i]}, and/or the group weight vector θ_{cc′} for each group. Expression 3 follows:

$${max}_{{{w}_{1} , {w}_{2} , … , {w}_{p}}_{{θ}_{11} , {θ}_{12} , … , {θ}_{pp}}} {\sum }_{i = 1}^{m} {\sum }_{j = 1}^{n} l ( {y}_{ij} ; {b}_{c [ i ]} + {w}_{c [ i ]}^{T} Φ ( {x}_{ij} ) + {\sum }_{{c}^{′} = 1}^{p} {θ}_{c [ i ] {c}^{′}}^{T} ψ ( {z}_{{c}^{′} j} ) , Δ t )$$

In this example, second model generation unit 110 uses the function of Expression 2 used in step S116 as its probability function.

In this manner, the information processing device 10 according to this embodiment is able to generate a second regression models incorporating the influence of word-of-mouth by taking in not only the event series, but also the group response series as explanatory variables of the regression models. Moreover, the information processing device 10 according to this embodiment is able to extract a group easily influenced by word-of-mouth. Therefore, the information processing device 10 is able to detect positive feedback among the sales of commodities, for example, caused by performing an advertisement distribution for this kind of group, so that sales promotion activities are able to be efficiently performed.

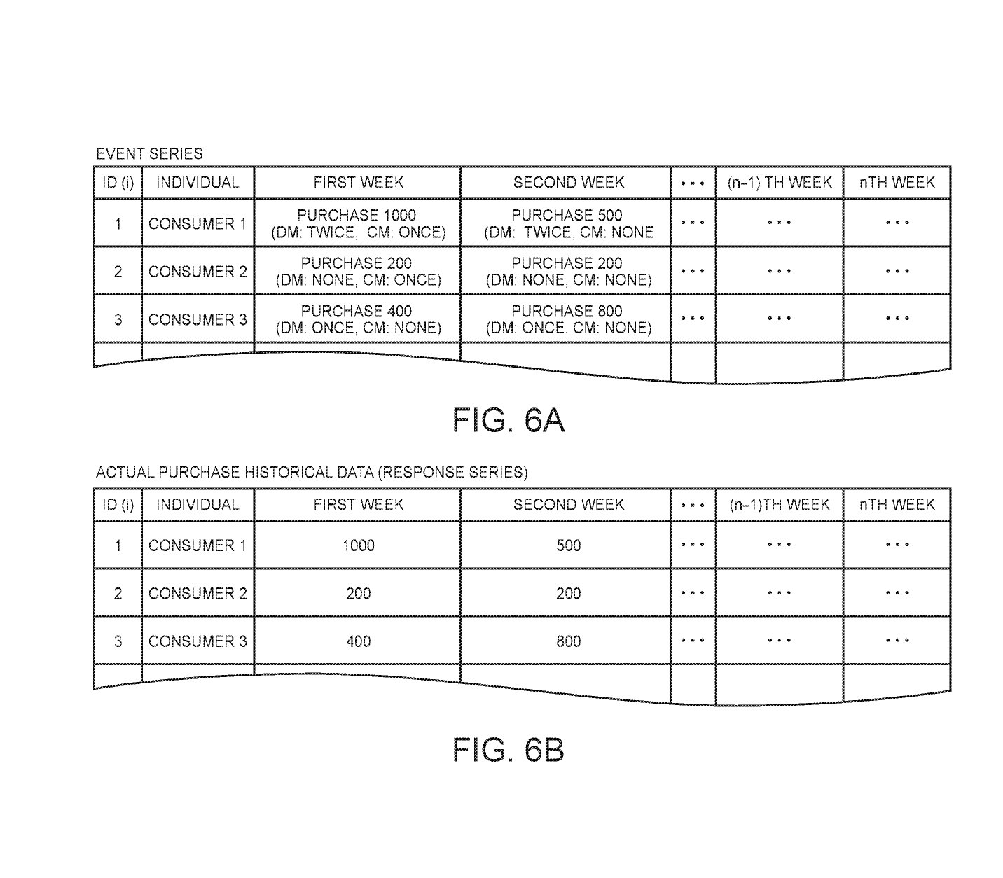

FIG. 6 illustrates an example of the event series and the response series of this embodiment. In step S100, the history acquisition unit 102 may acquire event series including the number of times that a direct mail is sent, the number of commercial times, and the purchase amount (or the total amount of purchases) of each consumer which have been provided as events to a plurality of consumers in the periods of the first week to the nth week as illustrated in FIG. 6A.

As illustrated in FIG. 6B, the history acquisition unit 102 may acquire the response series including the purchase amounts of a plurality of consumers in the periods of the first week to the nth week. As illustrated in FIGS. 6A and 6B, the event series includes the response series in this embodiment. Thereby, the first model generation unit 104 and the second model generation unit 110 are able to generate an autoregressive model. The history acquisition unit 102 also may acquire purchase recording data which is generated for each purchase and includes a direct mail, a commercial, the purchase date and time, and the purchase amount of each purchase to generate event series and response series having an interval of one week related to FIG. 6.

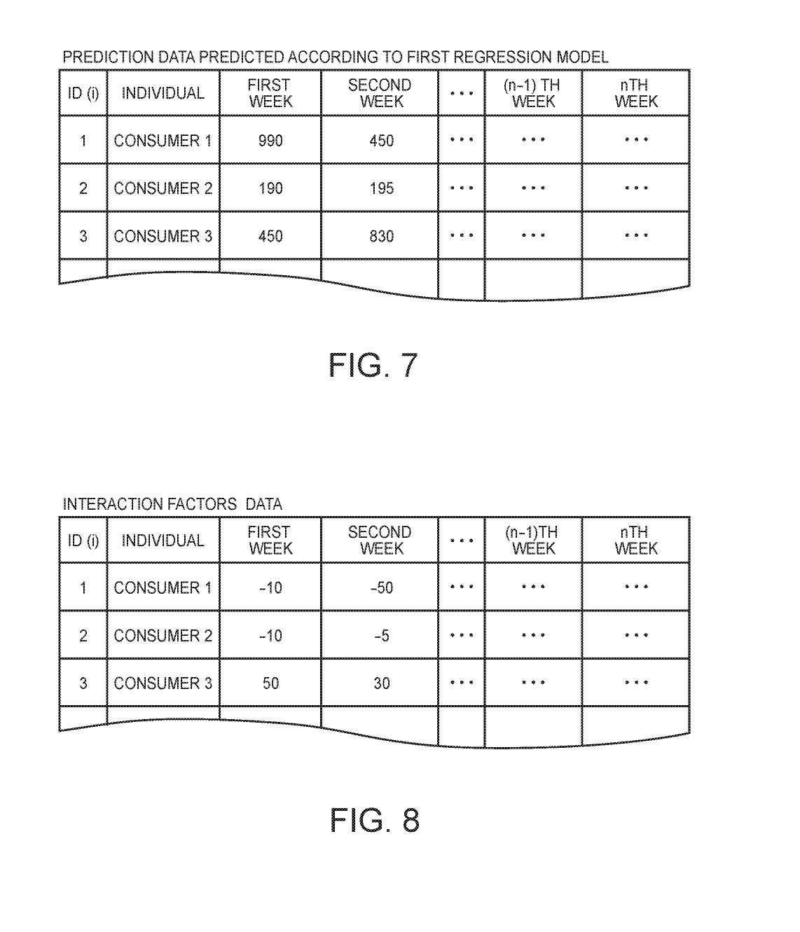

FIG. 7 illustrates an example of predicted scores according to the first regression model of this embodiment. In step S120, the influence calculation unit 106 may generate the first regression model on the basis of the event series and the response series illustrated in FIG. 6 and generate the prediction data of the response series illustrated in FIG. 7 according to the first regression model.

FIG. 8 illustrates an example of the interaction factor series of this embodiment. In step S120, the influence calculation unit 106 may generate the interaction factors illustrated in FIG. 8 from a difference between the response series illustrated in FIG. 6 and the prediction data illustrated in FIG. 7.

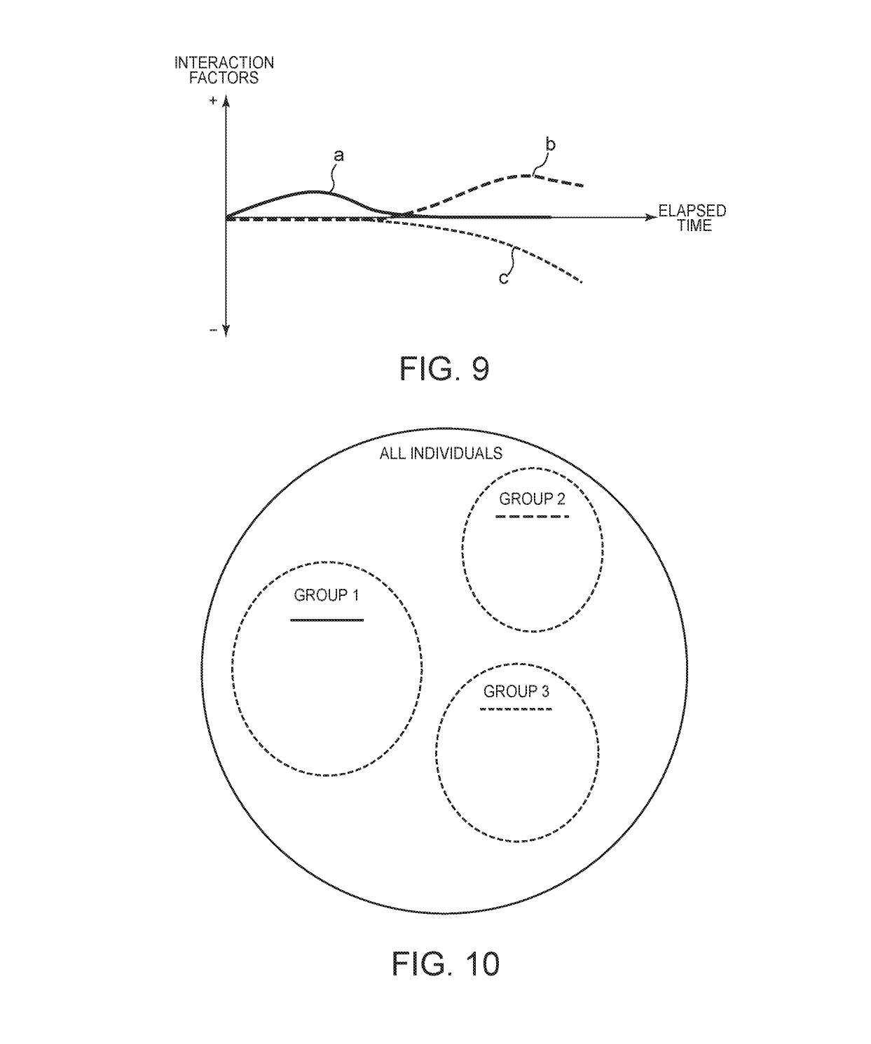

FIG. 9 illustrates an example of a pattern of the interaction factors in this embodiment. The influence calculation unit 106 generates a series of interaction factors that positively increase in the first half of the target period and decrease in the second half of the target period as indicated by a solid line “a” in FIG. 9 with respect to some “a” of individuals. These individuals “a” are considered to belong to a single group which is relatively sensitive to trends.

Moreover, the influence calculation unit 106 generates a series of interaction factors whose value is almost zero in the first half of the target period and positively increases in the second half of the target period as indicated by a dashed line “b” in FIG. 9 with respect to some “b” of individuals. These individuals “b” are considered to belong to a single group which is relatively insensitive to trends.

Moreover, the influence calculation unit 106 generates a series of interaction factors whose value is almost zero in the first half of the target period and negatively increases in the second half of the target period as indicated by a dotted line “c” in FIG. 9 with respect to some “c” of individuals. These individuals “c” are considered to belong to a single group which holds a negative view on trends.

FIG. 10 illustrates an example of grouping in this embodiment. As illustrated in FIG. 10, the relation detection unit 108 of this embodiment classifies all individuals into a plurality of groups 1 to 3 on the basis of the interaction factors.

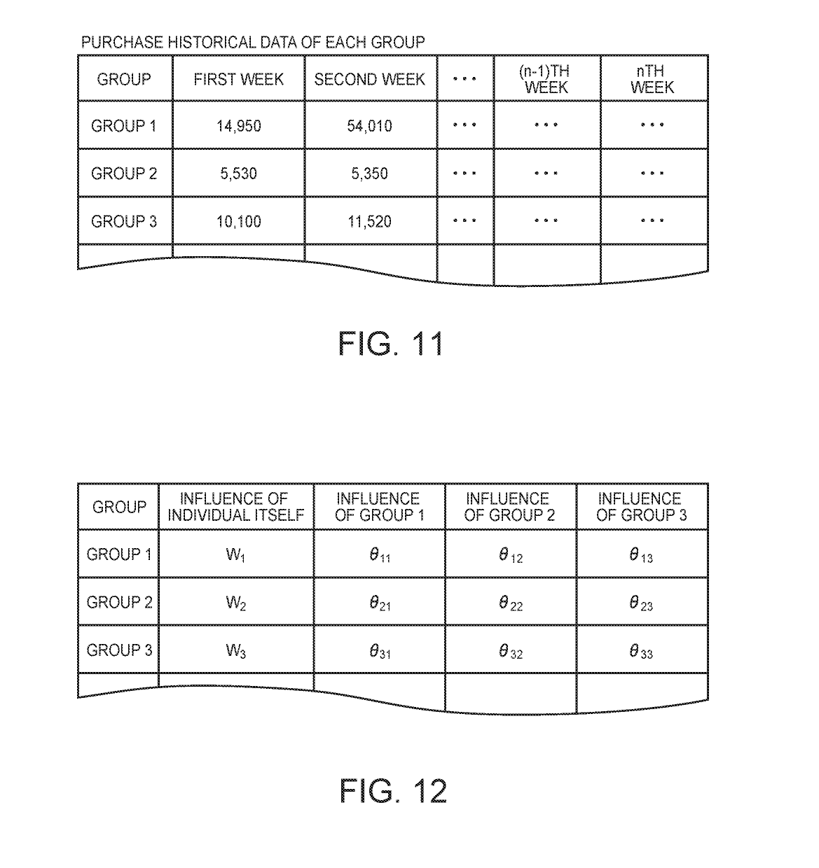

FIG. 11 illustrates an example of a group response series in this embodiment. In step S140, the second model generation unit 110 may acquire response series including the total of the purchase amount of consumers included in each group in the periods of the first week to the nth week as illustrated in FIG. 11.

FIG. 12 illustrates individual weight vectors and group weight vectors in this embodiment. As illustrated in FIG. 12, the second model generation unit 110 calculates individual group vectors w₁ to w₃ and group individual vectors θ₁₁ to θ₃₃ for the groups 1 to 3 in step S146.

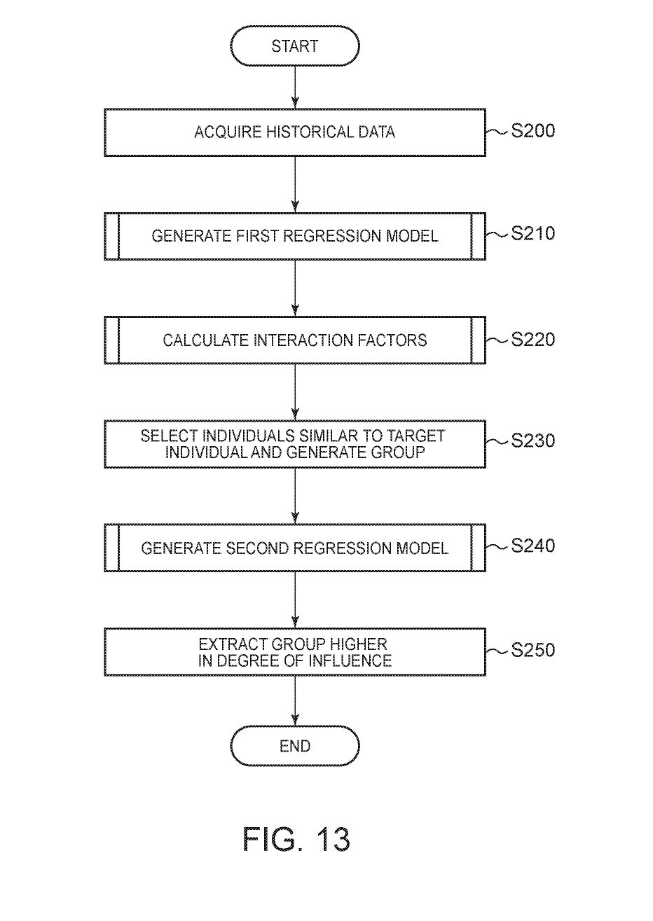

FIG. 13 illustrates the processing flow of the information processing device 10 according to a variation of the foregoing embodiment. In this variation of FIGS. 13 to 15, instead of classifying the plurality of individuals into the predetermined number of groups, the information processing device 10 generates a second regression model for each individual by generating a group including the individual and other individuals having interaction factors close to those of the aforementioned individual. In this variation, the information processing device 10 may perform the processes of steps S200, S210, and S220 in the same manner as the processes of steps S100, S110, and S120.

In step S230, based on the similarity between respective two of a plurality of interaction factors calculated with respect to a plurality of individuals, the relation detection unit 108 classifies each individual and two or more other individuals selected in the descending order of similarity of the interaction factors with respect to the aforementioned individual as a group. For example, the relation detection unit 108 may classify each individual and a predetermined number of other individuals selected in the descending order of similarity of the interaction factors with respect to the aforementioned individual as a group by using the k-nearest neighbor algorithm.

Alternatively, the relation detection unit 108 may classify each individual and other individuals whose similarity of the interaction factors is within a predetermined range with respect to the aforementioned individual as a group by using the ε-nearest neighbor algorithm. Moreover, the relation detection unit 108 may further classify an individual and other individuals similar to the individual as a group by applying a spectral clustering on the basis of the k-nearest neighbor algorithm or the ε-nearest neighbor algorithm. Thereby, the relation detection unit 108 according to the variation generates a group specific to each individual with respect to the plurality of individuals.

In step S240, the second model generation unit 110 generates a second regression model for predicting the response of an individual according to the event series for the individual itself and the group response series of the group including the individual, with respect to each individual. The concrete content of the process of step S240 will be described later.

In step S250, the information processing device 10 may perform the same process as the process of step S150.

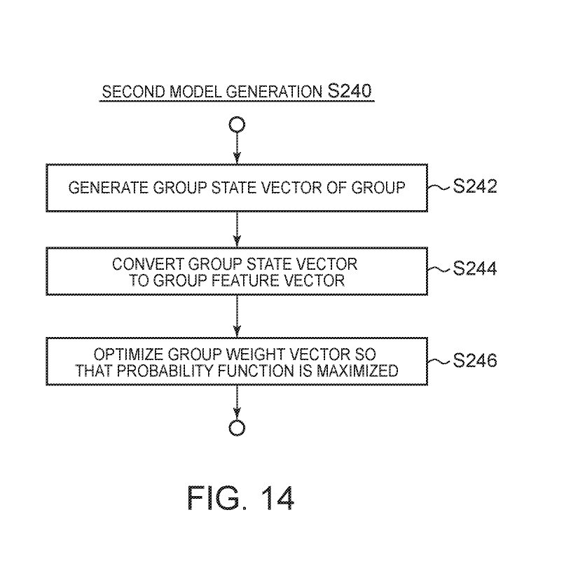

FIG. 14 illustrates the processing flow in step S240. The second model generation unit 110 performs the process of step S240 by performing the processes of steps S242 to S246.

[90] First, in step S242, the second model generation unit 110 generates a group response series. For example, the second model generation unit 110 generates a group response series for each individual by calculating the group state vector zᵢⱼ representing the total value of the number of responses and/or the response amount of the plurality of individuals in a group in the same manner as in step S142, with respect to the group for each individual generated in step S230. Moreover, the second model generation unit 110 also generates a state vector of an event series for each individual.

Next, in step S244, the second model generation unit 110 generates a group feature vector Ψ(zᵢⱼ) from the group state vector zᵢⱼ and generates a feature vector Φ(xᵢⱼ) from a state vector xᵢⱼ by the same process as in step S144.

Next, in step S246, the second model generation unit 110 performs Poisson regression with respect to each individual i and optimizes an individual weight vector w⁰ᵢ and a group weight vector θi by solving the optimization problem represented by Expression 4 (set forth below). The second model generation unit 110 may use the maximum likelihood estimation, MAP estimation, Bayesian estimation, or the like as a method of optimizing Expression 4. The second model generation unit 110 may use the function of the Expression 2 used in step S116 as the probability function 1. In this regard, the second model generation unit 110 may use a bias term b and/or a weight vector w independent of the individual i as the bias term bᵢ and/or the weight vector w⁰ᵢ. Expression 4 follows:

$${max}_{{{w}_{1} , {w}_{2} , … , {w}_{p}}_{{θ}_{1} , {θ}_{2} , … , {θ}_{m}}} {\sum }_{i = 1}^{m} {\sum }_{j = 1}^{n} l ( {y}_{ij} ; {b}_{i} + {w}_{i}^{0 T} Φ ( {x}_{ij} ) + {θ}_{i}^{T} ψ ( {z}_{ij} ) , Δ t )$$

In this manner, information processing device 10 according to this variation of FIGS. 13 to 15 is able to generate the second regression model incorporating the influence of word-of-mouth, with high accuracy. This high accuracy is achieved, by taking as an explanatory variable of the regression model, the group response series of the group generated for each individual.

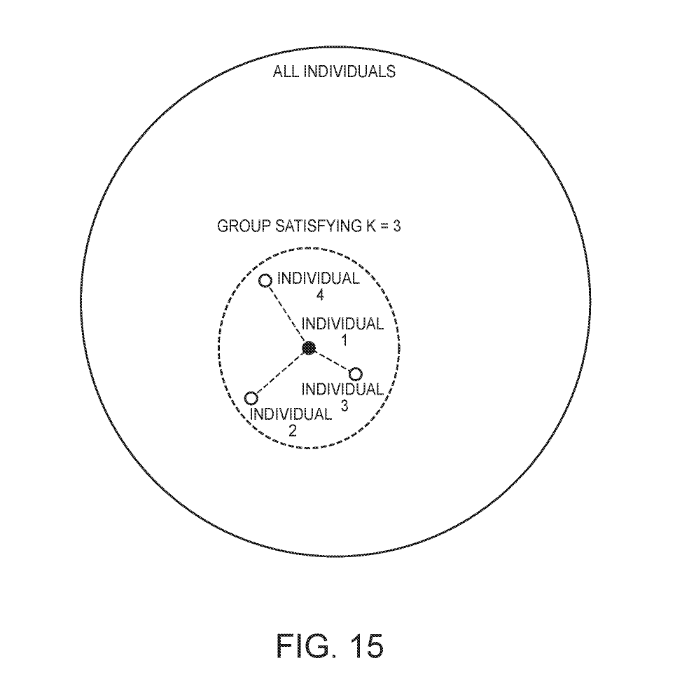

FIG. 15 illustrates an example of group generation according to the variation currently under discussion. As illustrated in FIG. 15, the relation detection unit 108 according to the variation forms a group, with a neighborhood number k equal to 3, including an individual 1 and individuals 2 to 4 which are the top three in the descending order of similarity in the interaction factors to the individual 1 with respect to the individual 1. The relation detection unit 108 also forms a group with a neighborhood number k equal to 3 for each of the individuals 2 to 4. Thereby, the information processing device 10 according to the variation generates a group specific to each individual.

The information processing device 10 according to the embodiment and the information processing device 10 according to the variation generated one component in a state vector and one component in a weight vector for one event (a direct mail or the like). Alternatively, however, the information processing device 10 may generate a plurality of components in the state vector and a plurality of components in the weight vector for one event. In this variation, information processing device 10 generates state vectors where each event occurs, instead of generating the state vectors corresponding to the periods T₁ to Tₙ each having the predetermined interval Δt. More specifically with respect to this generation of state vectors at locations where an event occurs, the state vectors in this variation correspond to periods T₁ to T_{q} respectively having intervals Δt′₁ to t′_{q} (where q is the number of event occurrences minus 1). Thereby, the information processing device 10 is able to model the response of the individual to an event with higher accuracy.

Moreover, the first model generation unit 104 and the second model generation unit 110 of the information processing device 10 according to the embodiment and those according to the variation generated the first regression model and the second regression models by using the Poisson regression. Alternatively, however, the first model generation unit 104 and the second model generation unit 110 may generate the first regression model and the second regression models by performing regression analyses other than the Poisson regression such as, for example, the least squares regression, the least absolute deviation regression, or the lognormal regression.

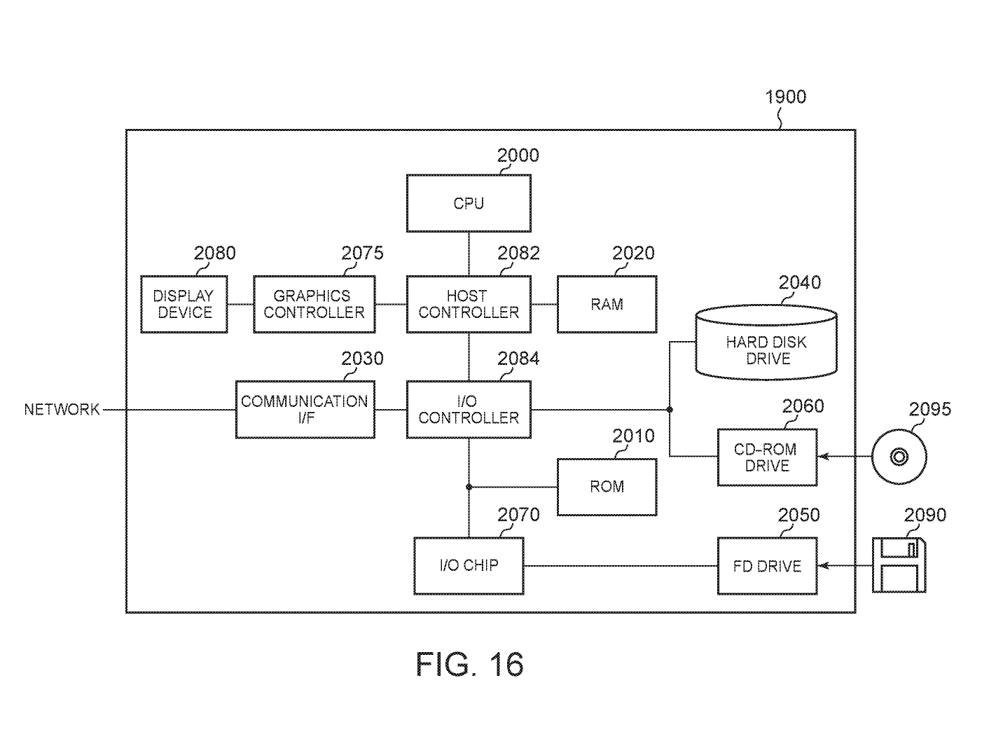

FIG. 16 illustrates an example of a hardware configuration of a computer 1900 which functions as the information processing device 10. The computer 1900 according to this embodiment includes a CPU peripheral unit, an input/output unit, and a legacy input/output unit. The CPU peripheral unit includes a CPU 2000, a RAM 2020, and a graphics controller 2075, all of which are mutually connected to one another via a host controller 2082. The CPU peripheral unit also includes a display device 2080. The input/output unit includes a communication interface 2030, a hard disk drive 2040, and a CD-ROM drive 2060, all of which are connected to the host controller 2082 via an input/output controller 2084. The legacy input/output unit includes a ROM 2010, a flexible disk drive 2050, and an input/output chip 2070, all of which are connected to the input/output controller 2084.

The host controller 2082 mutually connects the RAM 2020 to the CPU 2000 and the graphics controller 2075, both of which access the RAM 2020 at a high transfer rate. The CPU 2000 operates on the basis of a program stored in the ROM 2010 and the RAM 2020, and controls each of the components. The graphics controller 2075 acquires image data generated by the CPU 2000 or the like in a frame buffer provided in the RAM 2020, and causes the display device 2080 to display the acquired image data. In place of this, the graphics controller 2075 may internally include a frame buffer in which the image data generated by the CPU 2000 or the like is stored.

The input/output controller 2084 connects the host controller 2082 to the communication interface 2030, the hard disk drive 2040, and the CD-ROM drive 2060, all of which are relatively high-speed input/output devices. The communication interface 2030 communicates with another device via a network by wired or wireless communication. Moreover, the communication interface functions as hardware which performs communication. The hard disk drive 2040 stores, therein, a program and data to be used by the CPU 2000 in the computer 1900. The CD-ROM drive 2060 reads a program or data from a CD-ROM 2095 and provides the read program or data to the hard disk drive 2040 via the RAM 2020.

In addition, the input/output controller 2084 is connected to relatively low-speed input/output devices such as the ROM 2010, the flexible disk drive 2050, and the input/output chip 2070. The ROM 2010 stores a program such as a boot program executed at a start-up time of the computer 1900 and/or a program depending on hardware of the computer 1900 or the like. The flexible disk drive 2050 reads a program or data from a flexible disk 2090, and provides the read program or data to the hard disk drive 2040 via the RAM 2020. The input/output chip 2070 connects the flexible disk drive 2050 to the input/output controller 2084 and also connects various kinds of input/output devices to the input/output controller 2084 through a parallel port, a serial port, a keyboard port, a mouse port, and the like, for example.

A program to be provided to the hard disk drive 2040 via the RAM 2020 is provided by a user with the program stored in a recording medium such as the flexible disk 2090, the CD-ROM 2095, or an IC card. The program is read from the storage medium, then installed in the hard disk drive 2040 in the computer 1900 via the RAM 2020, and executed by the CPU 2000.

The program to be installed in the computer 1900 and to cause the computer 1900 to function as the information processing device 10 includes a history acquisition module, a first model generation module, an influence calculation module, a relation detection module, a second model generation module, and a group extraction module. The program or modules may direct the CPU 2000 or the like to cause the computer 1900 to function as the history acquisition unit 102, the first model generation unit 104, the influence calculation unit 106, the relation detection unit 108, the second model generation unit 110, and the group extraction unit 112.

Information processes written in these programs are read by the computer 1900 and thereby function as the history acquisition unit 102, the first model generation unit 104, the influence calculation unit 106, the relation detection unit 108, the second model generation unit 110, and the group extraction unit 112, all of which are specific means resulting from cooperation of software and the aforementioned various types of hardware resources. Then, the information processing device 10 specific to an intended purpose is built up by performing computation or processing of information in accordance with the intended purpose of the computer 1900 in this embodiment by use of such specific means.

In a case where communications between the computer 1900 and an external device or the like are performed, for example, the CPU 2000 executes a communication program loaded on the RAM 2020 and instructs the communication interface 2030 on the basis of processing contents described in the communication program to perform communication processing. Upon receipt of the control from the CPU 2000, the communication interface 2030 reads transmission data stored in a transmission buffer region or the like provided in a storage device such as the RAM 2020, the hard disk drive 2040, the flexible disk 2090, or the CD-ROM 2095 and then transmits the data to a network or writes reception data received from the network into a receiving buffer region or the like provided on a storage device. As described above, the communication interface 2030 is allowed to transfer transmission and reception data between itself and a storage device by a direct memory access (DMA) scheme. Instead of this, the CPU 2000 is also allowed to read data from a storage device of or a communication interface 2030 of a transfer source and then to transfer transmission and reception data by writing the data into a communication interface 2030 or a storage device of a transfer destination.

In addition, the CPU 2000 causes all of, or a required portion of, data to be read from a file or a database stored in an external storage device such as the hard disk drive 2040, the CD-ROM 2060 (CD-ROM 2095), the flexible disk drive 2050 (flexible disk 2090) or the like into the RAM 2020 by DMA transfer or the like, and then performs various kinds of processing for the data in the RAM 2020. Then, the CPU 2000 writes the processed data back in the external storage device by DMA transfer or the like. In such processing, since the RAM 2020 can be considered as a device in which the contents of an external storage device are stored temporarily, the RAM 2020 and an external storage device or the like are collectively termed as a memory, a storage unit, a storage device, or the like in this embodiment.

Various types of information including various types of programs, data, tables, databases, and the like in this embodiment are stored in such a storage device and are handled as an information processing target. It should be noted that the CPU 2000 is allowed to retain a part of data in the RAM 2020 in a cache memory and then to read and write the data in the cache memory. In this case as well, since the cache memory partially shares the function of the RAM 2020, the cache memory is considered to be included in the RAM 2020, a memory and/or a storage device except for a case where the cache memory needs to be distinguished from the RAM 2020, a memory, and/or a storage device in this embodiment.

In addition, the CPU 2000 performs, on the data read from the RAM 2020, various types of processing being specified by a sequence of instructions of the program and including various types of computations, information processing, conditional judgment, information retrieval and replacement and the like described in this embodiment, and writes the processed data back in the RAM 2020. In a case where the CPU 2000 performs conditional judgment, for example, the CPU 2000 determines by comparing a variable with the other variable or constant whether or not each of various types of variables indicated in the present embodiment satisfies a condition that the variable is larger, smaller, not less, not greater, equal, or the like. In the case where the condition is satisfied (or the condition is not satisfied), the processing of the CPU 2000 branches to a different instruction sequence or calls a subroutine.

In addition, the CPU 2000 is capable of searching for information stored in a file, a database, or the like in a storage device. For example, in a case where multiple entries having attribute values of a first attribute respectively associated with attribute values of a second attribute are stored in a storage device, the CPU 2000 searches the multiple entries stored in the storage device for an entry whose attribute value of the first attribute matches a specified condition. Then, the CPU 2000 reads an attribute value of the second attribute stored in the entry, and thereby, obtains the attribute value of the second attribute that satisfies the predetermined condition and that is associated with the first attribute.

The programs or modules described above may be stored in an external recording medium. As the recording medium, any one of the following media may be used: an optical recording medium such as a DVD or a CD; a magneto-optic recording medium such as an MO; a tape medium; and a semiconductor memory such as an IC card, in addition to the flexible disk 2090 and the CD-ROM 2095. Alternatively, the program may be provided to the computer 1900 via a network, by using, as a recording medium, a storage device such as a hard disk or a RAM provided in a server system connected to a private communication network or the Internet.

The present invention has been described hereinabove with reference to preferred embodiments. The technical scope of the present invention, however, is not limited to the above-described embodiments only. It is apparent to one skilled in the art that various modifications or improvements may be made to the above-described embodiments. Accordingly, it is also apparent from the scope of the claims that the embodiments with such modifications or improvements added thereto can be included in the technical scope of the invention.

It should be noted that the operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the operation flow is described using phrases such as “first” or “next” in the claims, embodiments, or diagrams, it does not necessarily mean that the process must be performed in this order.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The following paragraphs set forth some definitions for certain words or terms for purposes of understanding and/or interpreting this document.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Individual-related-entity: an individual or set of individuals.

What is claimed is:

1. An apparatus comprising:
a model creation component, wherein the model creation component is configured to generate a first regression model, wherein the first regression model predicts the reactions of a plurality of individuals in response to an event, and wherein the prediction is based on a series of historical reaction data associated with each of the individuals; and
an influence calculation component, wherein the influence calculation component is configured to compute a difference between the series of historical reaction data in the first regression model and the actual reaction data of each individual in response to an influence from the event.

2. The apparatus of claim 1, wherein the model creation component includes:
a processor; and
a computer readable storage medium; wherein:
the processor set is structured, located, connected and programmed to run program instructions stored on the computer readable storage medium; and
the program instructions include:
first program instructions programmed to receive a first historical data set including: (i) identifying information identifying a plurality of individuals, (ii) respectively corresponding to each individual, a plurality of event series with each event series including a set of events believed to be potentially relevant to a corresponding individual's behavior, and (iii) respectively corresponding to each event series, a set of actual response value(s), with each response value numerically indicating a corresponding individual's actual behavior believed to have been potentially influenced by the corresponding event series;

3. The apparatus of claim 1, wherein the influence calculation component includes:
a processor; and
a computer readable storage medium; wherein:
the processor set is structured, located, connected and programmed to run program instructions stored on the computer readable storage medium; and
the program instructions include:
second program instructions programmed to calculate, for each event series and using the first regression model, a set of predicted response value(s), with each predicted response value numerically indicating a prediction the corresponding individual's believed to have been potentially influenced by the corresponding event series, with each predicted response value corresponding to an actual response value; and
third program instructions programmed to calculate, for each corresponding actual response value and predicted response value for each event series of each individual, an interaction factor which is based upon the difference between the corresponding actual response and the predicted response value.

4. The apparatus of claim 3 further comprising:
fourth program instructions programmed to group the plurality of individuals into groups based upon similarities in interaction factors as between the members of the groups.

5. The apparatus of claim 2 wherein the medium further has stored thereon:
fourth program instructions programmed to develop a second regression model, based at least in part upon the interaction factors, with the second regression model being configured to calculate, a set of predicted response value(s) based on event series of individuals and on interactions between the individuals.
